(19) United States
(12) Patent Application Publication
(10) Pub. No.: US 2008/0295908 A1
(43) Pub. Date: Dec. 4, 2008

(54) Syngas Flow Diverter

(76) Inventor: Jacobus Neels, Rosedale (CA)

Correspondence Address: MCANDREWS HELD & MALLOY, LTD, 500 WEST MADISON STREET, SUITE 3400, CHICAGO, IL, 60661, US

(21) Appl. No.: 12/120,927

(22) Filed: May 15, 2008

Related U.S. Application Data
(60) Provisional application No. 60/938,098, filed on May 15, 2007.

(51) Int. Cl. F16K 11/074

(52) U.S. Cl. 137/625.46

(57) ABSTRACT

A passively cooled valve assembly selectively diverts a fluid stream from an inlet port selectively through at least one outlet conduit. The valve assembly comprises a housing defining the primary chamber. The housing also comprises at least one inlet port and at least two outlet conduits and associated outlet ports. A rotatable plate with at least one aperture formed therein is located within the primary chamber and is urged against an interior surface of the housing by a spring assembly. The rotatable plate is rotated by a shaft that extends axially through the primary chamber, in order to align the at least one aperture with at least one of the outlet conduits to allow selective fluid flow from an inlet port to an outlet conduit.

### CROSS-REFERENCE TO RELATED APPLICATION(S)

This application is related to and claims priority benefits from U.S. Provisional Patent Application Ser. No. 60/938,098, entitled “Syngas Flow Diverter”, filed on May 15, 2007, which is hereby incorporated by reference in its entirety.

### FIELD OF THE INVENTION

The present invention relates to valves used in fuel processor applications, in particular, valves that direct the flow of a product stream from a syngas generator. More specifically, the present invention relates to a diverter for selectively directing the product stream from a syngas generator to an exhaust after-treatment sub-system of a combustion engine system. The engine system can be part of a vehicular or non-vehicular system.

### BACKGROUND OF THE INVENTION

A fuel processor, such as a syngas generator (SGG) is a device that can convert a fuel into a gas stream containing hydrogen (H₂) and carbon monoxide (CO), commonly referred to as syngas. The product syngas stream of the SGG can reach temperatures of up to about 1200° C., and typically contains particulates such as soot or coke (carbon). A valve or syngas flow diverter (SGFD) can direct and/or distribute the flow of a syngas stream to one or more devices that utilize a syngas stream from a SGG. The extreme temperature of the syngas stream and the wide operating temperature range typical of an SGFD create challenges, for example, thermal expansion, thermal stresses, material durability and sealing.

A SGG can be employed to supply a syngas stream to regenerate an exhaust after-treatment sub-system of a combustion engine system. In engine system applications, it can be advantageous to use a portion of the exhaust stream from the engine as an oxidant reactant in the SGG, along with a suitable fuel. However, use of the engine exhaust stream as a reactant in the SGG limits the absolute pressure available to the SGG, and the lower SGG inlet pressure limits the acceptable pressure drop across the SGG and syngas distribution devices, including the SGFD. The SGFD should generally be low cost, reliable and durable. For vehicular applications it is also preferably compact, light-weight and efficiently packaged with other components of the engine system and/or exhaust after-treatment sub-system. The diverter should be capable of operating over a wide range of temperatures, for example, from below 0° C. up to at least 900° C., and should be capable of maintaining its seal integrity over its designed operating life, for example cycling every 10-600 seconds, over 5 years/100,000 miles of vehicular operation, or longer in the case of heavy duty trucks.

Prior approaches to overcome the extreme temperature challenges have involved the use of an active cooling system in order to remove heat from the diverter, and/or use of components manufactured from ceramic materials for increased durability. Disadvantages of using an active cooling system include: increased cost, increased system complexity, increased system volume requirements and, in some cases, an undesirable reduction in the temperature of the syngas stream as it passes through the diverter. A disadvantage of using components manufactured from ceramic materials is the increased product cost, particularly when the product is manufactured in limited production volumes.

The present approach overcomes at least some of these shortcomings and offers additional advantages. The present approach seeks to eliminate the requirement for an active cooling system and reduces the requirement for components made from ceramic materials.

### SUMMARY OF THE INVENTION

A valve assembly selectively diverts a fluid stream from an inlet port selectively through at least one outlet conduit and associated outlet port, via a primary chamber in the assembly. The valve assembly comprises a housing defining the primary chamber. The housing also comprises the at least one inlet port and at least two outlet conduits. A rotatable plate with at least one aperture or through-bore is located within the primary chamber and is urged against an interior surface of the housing by a spring assembly. The rotatable plate is rotated by a shaft that extends axially through the primary chamber, in order to align the at least one aperture with at least one of the outlet conduits. The valve assembly is passively cooled.

The valve assembly preferably further comprises an end cap assembly which extends outwardly from the housing and defines a secondary chamber. The spring assembly is located within the secondary chamber. At least one washer can be disposed between the primary and the secondary chambers to restrict access of the fluid to the spring assembly.

The spring assembly accommodates thermal expansion of the valve assembly components along the axis of the shaft. The spring assembly can comprise, for example, a compression spring.

An actuation device is generally coupled to selectively rotate the shaft and rotating plate. A position sensor can be used for valve-indexing by controlling relative alignment of the aperture and the at least one outlet conduit. Typically the apertures or through-bores have essentially the same diameter as the outlet conduits.

The above-described embodiments of a valve assembly can be used in a fuel processor system in which at least one inlet port of the valve assembly is connected to receive a hydrogen-containing gas stream from a fuel processor.

In preferred embodiments the valve assembly is used in a syngas flow gas diverter and the at least one inlet port is connected to receive a syngas stream from a syngas generator. The syngas flow diverter can be used in an engine system (comprising a combustion engine, a syngas generator, at least one exhaust after-treatment device) for selectively diverting syngas from the syngas generator to the at least one exhaust after-treatment device.

### BRIEF DESCRIPTION OF THE DRAWING(S)

FIG. 1 is an exploded view of a syngas flow diverter.

FIG. 2 is an exploded view of the syngas valve that is part of the syngas flow diverter illustrated in FIG. 1.

FIG. 3 is a side view of the syngas valve illustrated in FIG. 2, showing section lines A-A and B-B.

FIG. 4a is a sectional view illustrating Section A-A of the syngas valve illustrated in FIG. 3.

FIG. 4b is a sectional view illustrating Section B-B of the syngas valve shown in FIG. 3.

### DETAILED DESCRIPTION OF PREFERRED EMBODIMENT(S)

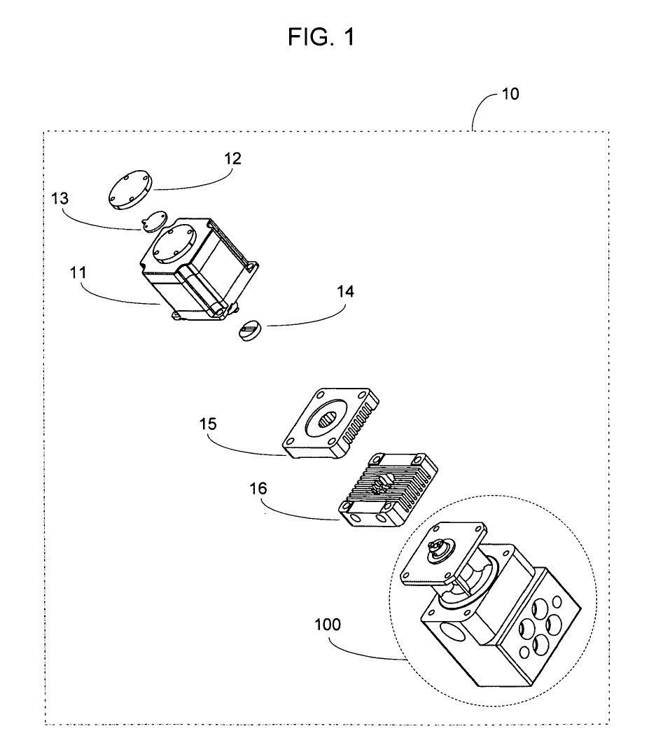

FIG. 1 is an exploded view of syngas flow diverter 10 which comprises syngas valve 100, spacer 16, insulating block 15, coupling 14, motor 11, Hall effect sensor 13 and cover 12. Hall effect sensor 13, protected by cover 12 and attached to motor 11, is employed to sense the position of syngas valve 100 and motor 11. Fasteners used to secure cover 12 to motor 11 are not shown in FIG. 1, but any suitable fastening mechanism can be used. A controller, also not shown in FIG. 1, is employed to actuate motor 11 based on pre-programmed logic and signals received from various devices including Hall effect sensor 13. Motor 11 rotates and positions syngas valve 100 through coupling 14. Motor 11 is an electric motor, although other suitable rotating or linear devices can be employed to actuate syngas valve 100.

Motor 11, insulating block 15 and spacer 16, are attached to syngas valve 100 with suitable fasteners (not shown in FIG. 1). Insulating block 15 assists in thermally shielding motor 11 from the extreme temperatures of the syngas stream (typically encountered during use of diverter 10) that is in contact with syngas valve 100. Insulating block 15 can be manufactured from a suitable material with a low thermal conductivity for example, plastic. Channels which are open from one side of the insulating block to the other are formed in insulating block 15 to enable the flow of air between adjacent components, and facilitate additional heat loss to the surrounding environment. Spacer 16, typically manufactured from metal, can also comprise open channels which enable the flow of air between adjacent components, and facilitate additional heat loss to the surrounding environment. A locating collar (not shown in FIG. 1) is used to locate insulating block 15 with spacer 16.

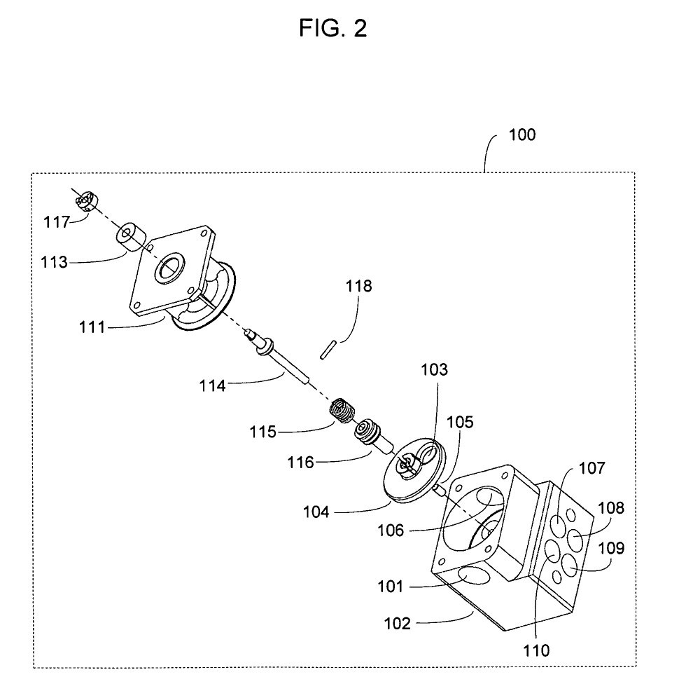

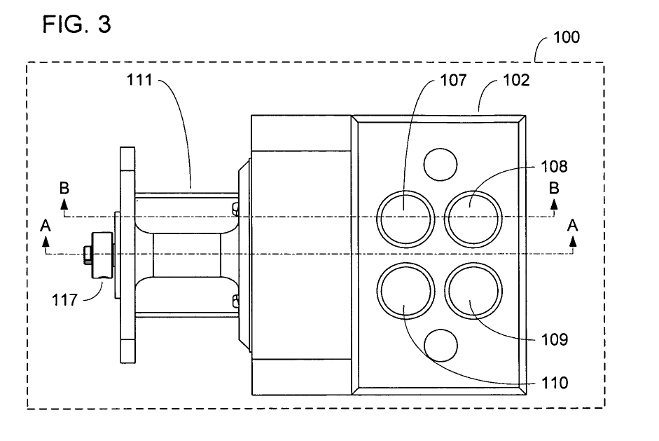

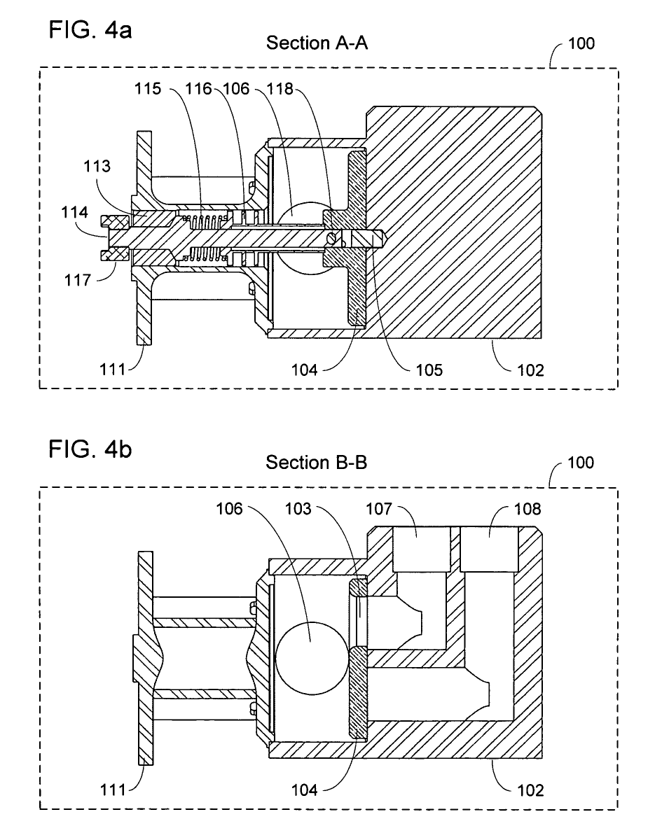

FIGS. 2, 3, 4a and 4b are illustrations of a syngas valve 100 which is a subcomponent of syngas flow diverter 10. During operation of the flow diverter a syngas stream enters syngas valve 100 though one or more inlet ports formed in manifold block 102, for example, inlet port 101 or inlet port 106. Inlet ports that are not required can be sealed or plugged. Manifold block 102 is a housing which defines a primary chamber in which a rotatable plate or disk 104 directs the flow of the syngas stream via a port 103, which is a through-bore or aperture formed in disk 104. Disk 104 is located by and rotates around a pin 105 which is located in manifold block 102. In a preferred embodiment, manifold block 102 is manufactured from commercially available materials capable of operating at high temperatures, such as stainless steel or nickel alloy materials. This results in a reduced product cost, compared to use of ceramic materials, especially when manifold block 102 is produced in limited production volumes. Disk 104 is manufactured from a suitable material, for example, a ceramic material, and comprises a flat surface which contacts and slides against a flat or sliding interior surface of manifold block 102. The sliding motion of disk 104 over the sliding surface of manifold block 102 can displace particulates that can deposit on that surface and/or disk 104, creating a self-cleaning capability. The surface finish and flatness of the contact surfaces between disk 104 and manifold block 102 are suitable to form a barrier to the flow of a gas stream between the two surfaces when disk 104 is urged against manifold block 102. Disk 104 and manifold block 102 are each of a suitable thickness to reduce the effects of heat distortion. As disk 104 is rotated, port 103 is at least periodically positioned to open up access from inlet port 101 or inlet port 106 to one of several outlet conduits 107, 108, 109 or 110 that are formed within manifold block 102, allowing the syngas stream to flow through manifold block 102 selectively via conduits 107, 108, 109 or 110 and exit valve 100 via corresponding outlet ports. The through-bore design of port 103 in disk 104 and conduits 107, 108, 109 and 110 extending through manifold block 102 reduces the pressure loss or drop across syngas valve 100. Preferably port 103 formed in disk 104 has essentially the same diameter as the entrances to outlet conduits 107, 108, 109 and 110. Conduits 107, 108, 109 and 110 can be fluidly connected to one or more device(s), not shown in the FIGS., which receive the syngas stream. In other embodiments disk 104 can comprise more than one aperture, enabling the flow of the syngas stream through more than one outlet conduit simultaneously. Two or more conduits can be formed in manifold block 102 of syngas valve 100; four conduits are shown in the embodiment illustrated in FIGS. 1-4 as an example. In other typically less compact embodiments, instead of being formed within a unitary manifold block 102, the outlet conduits can be separate components, for example, tubes or pipes attached to and extending from a base plate or housing.

Manifold block 102 and an end cap 111 are welded together after the assembly of the internal components. In a preferred embodiment, end cap 111 is manufactured from stainless steel or nickel alloy materials. This results in a reduced product cost, compared to use of ceramic materials, especially when end cap 111 is manufactured in limited production volumes. Bushing 113 is located and attached to end cap 111 by suitable means, for example, press fit. Bushing 113 locates one end of shaft 114, enables shaft 114 to be rotated, and forms a barrier between the syngas stream within end cap 111 and the external environment. A spring 115, is compressed and located by shaft 114 and a thrust washer 116. Spring 115 can be, for example, a helical compression spring manufactured from a suitable temperature resistive material such as, for example, inconel. Spring 115 provides a force to urge shaft 114 against bushing 113, and to urge thrust washer 116 and disk 104 towards manifold block 102. Spring 115 also allows for the thermal expansion of the components along the rotating axis of syngas valve 100. In preferred embodiments thrust washer 116 impedes and reduces the exposure of spring 115 to the syngas stream. Thrust washer 116 can comprise a plurality of annular fins which creates a resistance to convective heat transfer from the syngas stream to spring 115 via thrust washer 116. Also in preferred embodiments such as the illustrated embodiment, end cap 111 defines a secondary chamber in which bushing 113 and shaft 114 are suitably configured so that spring 115 is located at least somewhat separately from the main body of manifold block 102. This is to reduce the exposure of spring 115 to the extreme temperatures of the syngas stream and to locate spring 115 in a reduced temperature zone in order to reduce material creep that can result spring relaxation over time. Manifold block 102 can be insulated to reduce heat loss from the syngas stream. End cap 111 is preferably not insulated which allows heat to radiate to the surrounding environment. End cap 111 is preferably designed so that the temperature in the immediate area around spring 115 is maintained below about 300° C. and so that it reduces the heat conducted to temperature-sensitive devices (not shown in FIGS. 2-4) that can be attached to the end of end cap 111.

Motor 11 is coupled to shaft 114, via coupling 14 and ring 117, in order to rotate shaft 114, a rotating pin 118 and disk 104. Valve-indexing, to align the aperture in disk 104 with the conduits in manifold block 102, is performed by Hall effect sensor 13 which provides positional feedback and a controller. Shaft 114, is also located by disk 104 and pin 105, with a void between shaft 114 and pin 105, in order to allow for thermal expansion. Rotating pin 118 is located by shaft 114 and is unrestricted along the longitudinal axis to disk 104, again allowing for thermal expansion. Alternative positional feedback sensors or valve indexing devices can be used such as proximity switches or a Geneva wheel.

The valve component or overall flow diverter can be used in other fuel processing applications, for example, in a fuel processor and fuel cell system.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A valve assembly comprising:
(a) a housing defining a primary chamber, said housing comprising at least one inlet port and at least two outlet conduits;
(b) a shaft extending axially through said primary chamber;
(c) a rotatable plate located within said chamber, with at least one aperture, wherein said rotatable plate is rotatable by said shaft in order to align said at least one aperture with at least one of said outlet conduits; and
(d) a spring assembly for urging said rotatable plate against an interior surface of said housing within said primary chamber;
wherein said valve assembly is for selectively diverting a fluid stream from said at least one inlet port selectively through at least one of said outlet conduits via said primary chamber, wherein said valve assembly is passively cooled.

2. The valve assembly of claim 1 wherein said assembly further comprises an end cap assembly which extends outwardly from said housing and defines a secondary chamber, and wherein said spring assembly is located within said secondary chamber.

3. The valve assembly of claim 2 wherein there is at least one washer disposed between said primary and said secondary chamber to restrict access of said fluid to said spring assembly.

4. The valve assembly of claim 1 wherein said housing is made primarily of stainless steel or nickel alloy materials.

5. The valve assembly of claim 1 wherein said rotatable plate comprises a ceramic material.

6. The valve assembly of claim 1 wherein said spring assembly comprises an inconel material.

7. The valve assembly of claim 1 wherein said spring assembly comprises a compression spring.

8. The valve assembly of claim 2 wherein said end cap assembly is made primarily of stainless steel or nickel alloy materials.

9. The valve assembly of claim 1 wherein said spring assembly accommodates thermal expansion of said valve assembly components along the axis of said shaft.

10. The valve assembly of claim 1 wherein said at least one aperture has essentially the same diameter as said at least one outlet conduit.

11. The valve assembly of claim 1 further comprising an actuation device coupled to selectively rotate said shaft and rotating plate.

12. The valve assembly of claim 1 further comprising a motor, wherein said shaft is coupled to said motor for rotating said shaft and said rotating plate.

13. The valve assembly of claim 1 further comprising a position sensor for valve-indexing by controlling relative alignment of said aperture and said at least one outlet conduit.

14. The valve assembly of claim 13 wherein said position sensor comprises a Hall effect sensor.

15. The valve assembly of claim 14 further comprising a motor, wherein said Hall effect sensor is coupled to said motor for controlling relative alignment of said aperture and said at least one outlet conduit.

16. A fuel processor system comprising a fuel processor for producing a hydrogen-containing gas stream and the valve assembly of claim 1, wherein said at least one inlet port is connected to receive said hydrogen-containing gas stream from said fuel processor.

17. A syngas flow diverter comprising the valve assembly of claim 1 wherein said at least one inlet port is connected to receive a syngas stream from a syngas generator.

18. An engine system comprising a combustion engine, a syngas generator, at least one exhaust after-treatment device and the valve assembly of claim 1 for selectively diverting syngas entering said primary chamber from said syngas generator via said at least one inlet port to said at least one exhaust after-treatment device via at least one of said outlet conduits.
